(19) United States
(12) Patent Application Publication
(10) Pub. No.: US 2026/0270884 A1
(43) Pub. Date: Sep. 10, 2026

(54) TONE RESERVATION MULTIPLEXING SCHEME BASED ON TRANSMIT POWER

(71) Applicant: InterDigital Patent Holdings, Inc., Wilmington, DE (US)

(72) Inventors: Aata El Hamss, Laval (CA); Paul Marinier, Brossard (CA); Erdem Bala, East Meadow, NY (US); Moon-il Lee, Melville, NY (US); Virgil Comsa, Montreal (CA)

(73) Assignee: InterDigital Patent Holdings, Inc., Wilmington, DE (US)

(21) Appl. No.: 19/167,741

(22) PCT Filed: Mar. 27, 2024
(86) PCT No.: PCT/US2024/021636

§ 371 Date: Sep. 22, 2025

Related U.S. Application Data
(60) Provisional application No. 63/456,288, filed on Mar. 31, 2023.

(51) Int. Cl. H04W 52/14

(52) U.S. Cl. CPC H04W 52/146

(57) ABSTRACT

Systems, methods, devices, and instrumentalities are described herein related to tone reservation (TR). A wireless transmit/receive unit (WTRU) may receive configuration information from a base station. The configuration information may associate a transmit power range (e.g., a first transmit power range and a second transmit power range) with a multiplexing scheme (e.g., a first multiplexing scheme and a second multiplexing scheme). The WTRU may receive an uplink grant associated with an uplink transmission. The WTRU may determine a transmit power range to be used for the uplink transmission. The WTRU may determine that the transmit power is in the transmit power range. The WTRU may determine to use a multiplexing scheme that corresponds to the determined transmit power. Based on the determination, the WTRU may send a tone multiplexed with data (e.g., for the uplink transmission) in accordance with the determined multiplexing scheme.

### CROSS-REFERENCE TO RELATED APPLICATIONS

This application claims the benefit of U.S. Provisional Application Ser. No. 63/456,288 filed Mar. 31, 2023, the contents of which are incorporated by reference herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, devices, and instrumentalities are described herein related to tone reservation. A device, such as a wireless transmit/receive unit (WTRU), may receive a configuration and/or configuration information. For example, a WTRU may receive configuration information from a base station. An example of a base station may be a gNB. The configuration may associate a transmit power range with a multiplexing scheme. In examples, the configuration information may associate a first transmit power range with a first multiplexing scheme. In examples, the configuration information may associate a second transmit power range with a second multiplexing scheme. The multiplexing scheme may be associated with multiplexing between a tone reservation (TR) transmission (e.g., a tone and/or a TR signal) and a data transmission that are associated with an uplink transmission. For example, an uplink transmission may be, or may include, a TR transmission multiplexed with a data transmission (e.g., an uplink data transmission). The tone that is being multiplexed with the data described herein may be associated with a TR signal and/or a TR transmission. For example, the term tone and a TR signal may be used interchangeably.

The WTRU may receive an uplink grant. The uplink grant may be associated with the uplink transmission. As described herein, the uplink transmission may be, or may include a TR transmission and/or a data transmission. The WTRU may receive the uplink grant using at least one of uplink control information (UCI) or medium access control (MAC) control element (CE), e.g., from the base station. In examples, the configuration information may be configured for a period of time and/or a number of uplink grants.

The WTRU may determine a transmit power range to be used for an uplink transmission (e.g., that is associated with the uplink grant). The WTRU may determine that the transmit power is in a transmit power range. In examples, the transmit power range may be a first transmit power range. In examples, the transmit power range may be a second transmit power range.

In examples, the first transmit power range may be associated with a first puncturing pattern configured to multiplex the tone with the data. In examples, the first transmit power range may be associated with a first number of resource elements (REs) configured to multiplex the tone with the data using a rate matching. In examples, the second transmit power range may be associated with a second puncturing pattern configured to multiplex the tone with the data. In examples, the second transmit power range may be associated with a second number of REs configured to multiplex the tone with the data using the rate matching. In examples, the first puncturing pattern may differ from the second puncturing pattern. In examples, the first number of REs may differ from the second number of REs. The transmit power range may be associated with at least one of absolute values associated with powers, offsets associated with a maximum transmission power, or offsets associated with a configured maximum transmission power for the uplink transmission.

The WTRU may determine a multiplexing scheme, e.g., for the uplink transmission. For example, based on the determined transmit power range, the WTRU may determine a corresponding multiplexing scheme between the TR transmission and the uplink data transmission. Based on the determined transmit power range (e.g., power range on which the determined transmit power belongs to) and/or the configuration, the WTRU may determine to use a multiplexing scheme. For example, the WTRU may determine to use the multiplexing scheme that corresponds to the determined transmit power range. The determined multiplexing scheme may be the first multiplexing scheme or the second multiplexing scheme (e.g., and so on).

The WTRU may indicate the multiplexing scheme to be used. For example, the WTRU may send an indication to a base station, and the indication may indicate the multiplexing scheme to be used for multiplexing the TR transmission and the uplink data transmission. The WTRU may send the indication using at least one of uplink control information (UCI) and/or medium access control (MAC) control element (CE).

Based on the determination to use the multiplexing scheme, the WTRU may send an uplink transmission. For example, the WTRU may send a tone with data in accordance with the determined multiplexing scheme. In examples, the WTRU may multiplex the tone with the data in accordance with the first multiplexing scheme, e.g., for the associated uplink transmission. In examples, the WTRU may multiplex the tone with the data in accordance with the second multiplexing scheme, e.g., for the associated uplink transmission.

The WTRU may transmit the uplink grant. For example, the WTRU may transmit the uplink grant using the UCI and/or the MAC CE.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example tone reservation (TR) pattern to multiplex tone reservation with data transmission.

FIG. 3 illustrates an example flow diagram of a TR multiplexing scheme based on transmit power.

FIG. 4 illustrates an example flow diagram enabling rate matching for a transmission with TR.

FIG. 5 illustrates an example flow diagram for enabling rate matching for retransmission with TR.

FIG. 6 illustrates an example of flow diagram of determining one or more TR resources for one or more slot transmissions.

### DETAILED DESCRIPTION

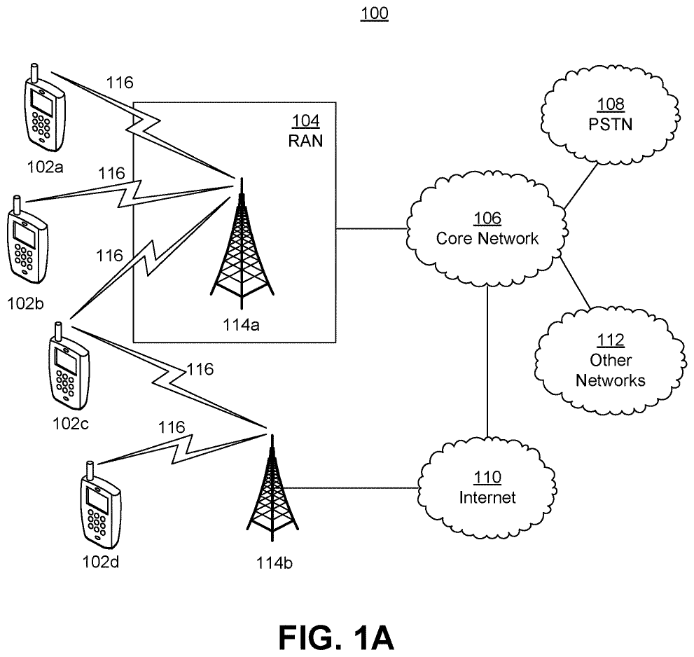

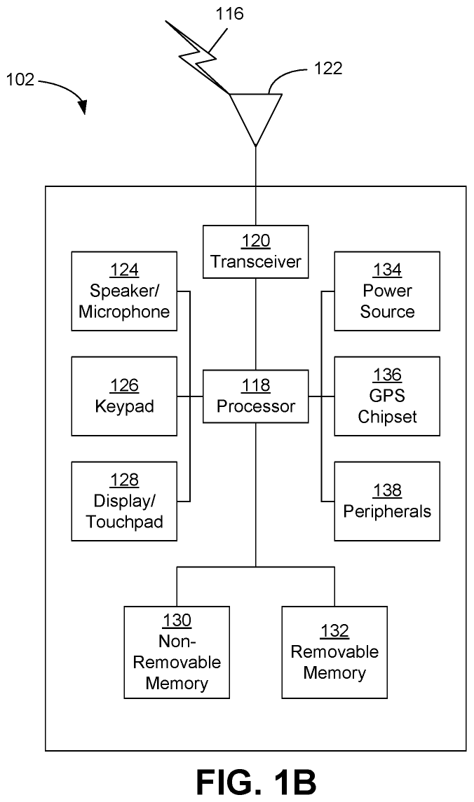

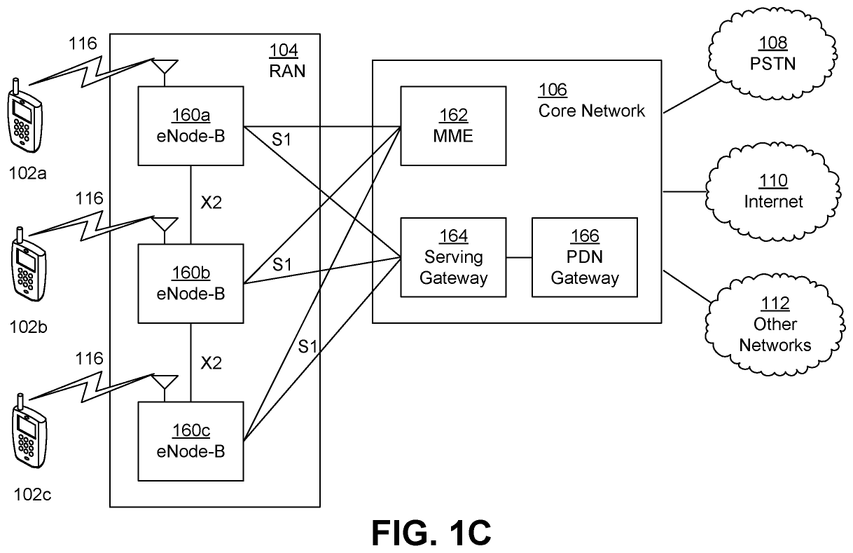

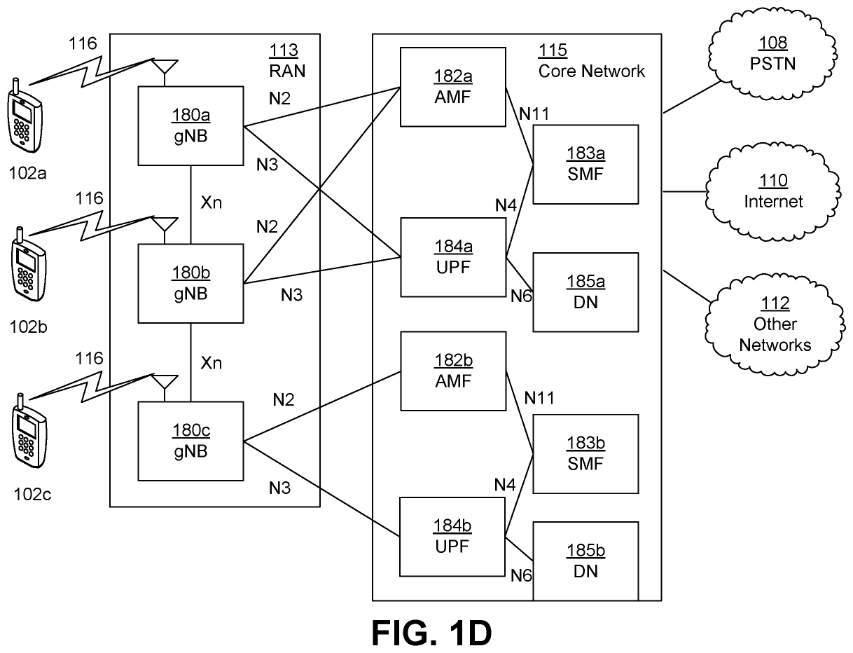

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Transmission power (e.g., average transmission power) may have an impact (e.g., a direct impact) on a block error rate (BLER) of one or more transmissions. To reduce a BLER of a transmission, the power may be increased. The transmission power (e.g., the maximum transmission power) may be limited, for example, due to power amplifier limitation. For example, the power level in an input of an amplifier may be in a linear region, for example, to avoid distortion and/or a non-linear behavior. The limitation described herein may be more pronounced in one or more power amplifiers of WTRUs, for example, compared to one or more power amplifiers of a base station, such as a gNB. The peak of the power may be configured to be closer to an average power of the transmitted signal (e.g., to minimize the limitation of the power amplifier). For example, the peak of the power may be configured to be closer to the average power of the transmitted signal and the average power may be increased, for example, while operating in a linear region. For example, the average power may be increased as described herein while operating in a linear region, e.g., to reduce a peak to average power ratio (PAPR).

Uplink coverage may have an impact(s). With a transmission scheme that has a high PAPR, a device, such as a WTRU, may reduce (e.g., may be forced to reduce) the average power, for example, due to one or more examples described herein. With reduced average power, an example(s) may exist on the minimum achievable BLER of a transmission. In examples, a WTRU, such as a cell center WTRU, may achieve a desirable performance (e.g., a good performance) for an uplink transmission. For example, a cell center WTRU may achieve a desirable performance (e.g., a good performance) for an uplink transmission based on the location of the cell center WTRU (e.g., the call center WTRU may be closer to a base station (e.g., a gNB)). In examples, a WTRU, such as a cell edge WTRU(s), may fail to achieve (e.g., may not achieve) a BLER target (e.g., a desirable BLER target) for a transmission. For example, a cell edge WTRU may transmit at a maximum power and may not achieve (e.g., fail to achieve) a BLER target (e.g., a desirable BLER target).

Tone reservation (TR) and/or TR signal may be used and/or configured. For example, TR may be used and/or be configured to reduce PAPR of a transmission. One or more resources (e.g., one or more additional resources) in a frequency domain may be used. A signal carrying data intended for transmission may have one or more peaks. One or more peaks in a signal carrying data intended for a transmission may cause a high PAPR (e.g., also known as an original signal). To reduce the peak of the signal (e.g., the original signal), a cancelation signal may be added to the signal (e.g., the original signal). For example, a cancelation signal may be added to the original signal using one or more resources in the frequency domain. The peak of the sum of the signals may be reduced, for example, providing a lower PAPR of the sum of the signals. By reducing the PAPR, higher transmission power may be achieved and/or may have a higher coverage for the transmission. The one or more frequency resources used to transmit the cancelation signal may be called reserved tones and/or reserved resources for tone reservation. In a system (e.g., an NR system), the granularity of the reserved tones may be resource elements and/or resource blocks (RBs). In examples, the resource reserved for tone reservation may be separate from one or more RBs allocated for an uplink transmission to transmit data.

In examples, if TR is transmitted within an RB allocated for data, one or more resource elements (REs) used for TR may be configured. In an example, if TR may be transmitted within an RB allocated for data, a base station (e.g., a gNB) may be configured to know one or more tone reservation resources, e.g., to decode an uplink transmission.

In examples, a WTRU may multiplex a tone and/or a TR signal associated with a tone reservation (e.g., TR transmission). For example, a tone reservation multiplexing scheme may be based on transmit power. In examples, if a WTRU operates close to the maximum transmit power, a reduction of PAPR (e.g., as described herein) may be useful for tone reservation.

A WTRU may be configured with one or more transmit power ranges. For example, a power range may be associated with a multiplexing scheme of TR and/or an uplink grant (e.g., a respective power range may be associated with a respective TR multiplexing scheme of TR). A multiplexing scheme may be and/or may include puncturing (e.g., including a puncturing pattern), rate matching (e.g., including how many resources to use for data transmission), and/or a transmission without TR. The WTRU may receive an uplink grant and may determine a transmit power for the transmission (e.g., the uplink transmission associated with the uplink grant). The WTRU may determine the multiplexing scheme between the TR and the uplink grant. For example, the WTRU may determine the multiplexing scheme between the TR and the uplink grant based on the range to which transmit power belongs. Based on the determined multiplexing scheme, the WTRU may send the uplink transmission (e.g., including the data transmission and/or the TR transmission).

A WTRU may receive a configuration and/or configuration information from a base station, such as a gNB. The configuration/configuration information received from the base station may indicate an association between a transmit power range and a multiplexing scheme of TR and an uplink data transmission. For example, the configuration/configuration information may be one or more of a first power range, a second power range, a third power range, a fourth power range, and/or a fifth power range. In examples, the configuration information may associate a first transmit power range with a first multiplexing scheme and associate a second transmit power range with a second multiplexing scheme.

A first power range may be associated with an uplink data transmission (e.g., data without a tone reservation, for example data without a multiplexing tone). For example, a first power range may be, or may include, [P0, P1]. A second power range may be associated with a first puncturing pattern to multiplex a tone (e.g., TR signal) with an uplink data transmission. For example, a second power range may be, or may include, [P1, P2]. A third power range may be associated with a second puncturing pattern to multiplex a tone (e.g., TR signal) with an uplink data transmission. For example, a third power range may be, or may include, [P2, P3]. A fourth power range may be associated with a first number of REs to use for a tone (e.g., TR signal) with an uplink data transmission and/or rate match the data transmission on the remaining REs of an uplink grant. For example, a fourth power range may be, or may include, [P3, P4]. A fifth power range may be associated with a second number of REs to use for a tone (e.g., TR signal) with an uplink data transmission and/or rate match the data transmission on the remaining REs of an uplink grant. For example, a fifth power range may be, or may include, [P4, P5].

The WTRU may receive the uplink grant. The uplink grant may be associated with the uplink transmission. For example, the uplink transmission may be associated with performing uplink data transmission and/or multiplexing the uplink data transmission with a tone as described herein.

The WTRU may determine the transmit power associated with the uplink grant. For example, the WTRU may determine the transmit power to be used for the uplink transmission associated with the uplink grant.

As illustrations of described herein, the WTRU may determine that the transmit power is in a transmit power range. In examples, the transmit power range may be the first transmit power range or the second power range described herein. In examples, the transmit power range may be the second transmit power range or the third power range described herein. In examples, the transmit power range may be the fourth transmit power range or the fifth power range described herein.

The WTRU may determine to use a multiplexing scheme. As described herein, the multiplexing scheme may be a first multiplexing scheme or a second multiplexing scheme. The multiplexing scheme may multiplex a tone (e.g., TR signal) with data (e.g., the uplink data transmission) for an uplink transmission. For example, a WTRU may determine a multiplexing scheme between a tone (e.g., TR signal) associated with the TR transmission and the uplink data transmission, e.g., for the uplink transmission, based on the power range on which the determined transmit power belongs.

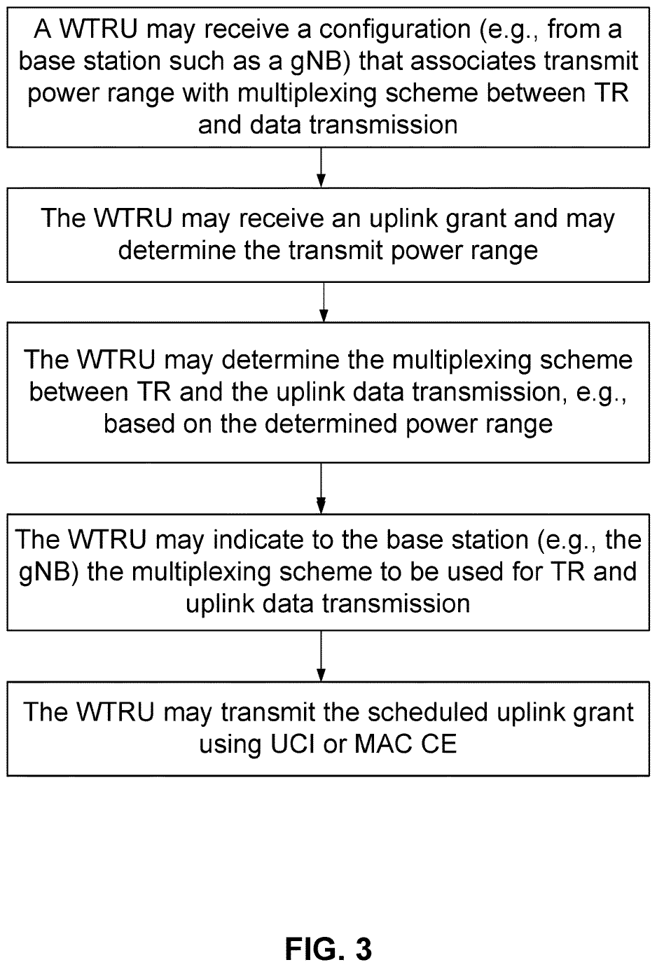

The WTRU may indicate (e.g., may send an indication indicating) to a base station, such as a gNB, the multiplexing scheme being used (e.g., for the uplink transmission), as illustrated in FIG. 3. The indication may indicate the multiplexing scheme being used to multiplex and to transmit a tone (e.g., TR signal) with data transmission. The WTRU may use uplink control information (UCI) and/or medium access control (MAC) control element (CE) to send the indication. For example, UCI may be piggybacked in physical uplink shared channel (PUSCH) transmission carrying a tone (e.g., TR signal). For example, a MAC CE may be transmitted before the PUSCH transmission carrying a tone (e.g., TR signal).

A WTRU may transmit the tone (e.g., the TR signal) multiplexed with PUSCH transmission as illustrated in FIG. 3.

In examples, rate matching for a transmission (e.g., an initial transmission with a tone, such as TR signal) may be enabled. As described herein, a WTRU may be configured with a target transport block size (TBS) reduction. As illustrations of described herein, the WTRU may receive configuration information, e.g., from a base station. The configuration information may be, or may include, TBS reduction information. The TBS reduction information may be, or may include, a target TBS reduction (e.g., a target TBS reduction value). The target reduction value may be associated with a percentage and/or a number of bits to be subtracted from a TBS value. The target TBS reduction may be supported if a tone (e.g., tone reservation signal) is multiplexed with an uplink data transmission, e.g., for an uplink transmission. For example, the WTRU may determine the number of REs to be used for a tone (e.g., TR signal) associated with tone reservation, for example, based on target TBS reduction.

The WTRU may be configured with target TBS reduction information. For example, the WTRU may be configured with a target TBS reduction if tone reservation is to be used on a transmission (e.g., an initial transmission). The configured target TBS reduction may indicate how much a calculated TBS may be reduced. In examples, a target TBS reduction may be represented in a percentage (e.g., 10%) of bits that may be subtracted from a TBS value. In examples, a target TBS reduction may be a number of bits that is subtracted from a TBS value.

The WTRU may receive an uplink grant. The uplink grant may be associated with an initial uplink transmission. For example, the uplink grant may be associated with a new data indicator (NDI). For example, the NDI may be toggled for a HARQ process ID (e.g., an initial transmission). As illustrations of described herein, the WTRU may determine that an NDI associated with the uplink grant has been toggled for a HARQ ID. Based on the determination that the NDI associated with the uplink grant has been toggled for a HARQ ID, the WTRU may determine that the uplink grant is associated with an initial uplink transmission.

The WTRU may enable multiplexing a tone (e.g., TR signal) associated with a tone reservation with data for an uplink transmission, e.g., the initial uplink transmission associated with the uplink grant.

Based on the determination that the uplink transmission has been enabled to multiplex the tone with the data, the WTRU may determine a TBS associated with the uplink transmission. As described herein, the uplink transmission may be, or may include a tone transmission multiplexed with a data transmission. In examples, the WTRU may calculate the TBS. For example, the WTRU may calculate and/or determine a TBS value based on and/or using the indicated modulation and coding scheme (MCS) and one or more available REs. For example, based on the number of allocated REs in the scheduled uplink grant and/or by excluding the overhead REs, the WTRU may determine the one or more available REs (e.g., a number of available REs). The WTRU may apply the target TBS reduction to the obtained TBS value. For example, the WTRU may subtract the target TBS reduction from the obtained TBS value.

The WTRU may determine a number of REs for data transmission using the calculated TBS as described herein.

The WTRU may use one or more remaining REs of the scheduled uplink grant for multiplexing a tone (e.g., tone signal) transmission. For example, based on the number of REs associated with data/data transmission, the WTRU may determine a number of REs associated with the tone transmission. The WTRU may send the tone transmission using the number of REs associated with the tone transmission and may send the data transmission using the number of REs associated with the data transmission.

The WTRU may perform a PUSCH transmission. For example, the WTRU may perform a PUSCH transmission using the number of REs associated with the tone transmission and the number of REs associated with the data transmission. As described herein, the tone transmission may be multiplexed with the data transmission.

In examples, rate matching may be enabled for retransmission with a tone (e.g., TR signal). One or more retransmissions may have different coding rate(s) from a transmission (e.g., an initial transmission) as described herein.

A WTRU may be configured with a coding rate increase. For example, the WTRU may receive configuration information, e.g., from a base station. The configuration information may be associated with a coding rate increase. The coding rate increase may be supported if the tone (e.g., TR signal) is multiplexed with an uplink data transmission.

As illustrations of described herein, the WTRU may receive an uplink grant. For example, the WTRU may receive a first uplink grant. The first uplink grant may be, or may include, a first DCI. The first DCI may be, or may include an NDI associated with the first uplink grant. The NDI may be toggled for a HARQ process ID. Based on the NDI, the WTRU may determine that the first uplink transmission is associated with an initial uplink transmission.

For example, the WTRU may receive a DCI (e.g., a first DCI) that schedules a transmission (e.g., a first transmission for a HARQ process). For example, the transmission (e.g., the first uplink transmission) may be for data (e.g., new data). The DCI (e.g., the first DCI) may be, or may include, information that the WTRU uses to determine a modulation order (e.g., a first modulation order) and/or a target coding rate (e.g., a first target coding rate).

The WTRU may determine a first modulation order and a first target coding rate to be used for a first uplink transmission. The first uplink transmission may be associated with the first uplink grant.

The WTRU may transmit the uplink transmission (e.g., the first uplink transmission). For example, the WTRU may transmit the first transmission (e.g., a first PUSCH), based on the first modulation order and/or the first target coding rate. The WTRU may send the first uplink transmission based on the first modulation order and the first target coding rate. As described herein, the first uplink transmission may be an initial uplink transmission.

The WTRU may receive a second uplink grant. Based on the second uplink grant, the WTRU may determine a second target coding rate to be used for a second uplink transmission and a number of allocated REs. In examples, the WTRU may receive a DCI (e.g., a second DCI) scheduling a transmission (e.g., a second transmission for the HARQ process). For example, the transmission (e.g., the second transmission) may be a retransmission (e.g., of the first transmission). The second DCI may be, or may include, information that the WTRU uses to determine a number of allocated REs.

As illustrations of described herein, the second uplink transmission may be associated with the second uplink grant. The second uplink grant may be, or may include, a second DCI. The second uplink grant may indicate that the second uplink transmission is a retransmission of the first uplink transmission.

As illustrations of described herein, the WTRU may determine that the second uplink transmission has been enabled to multiplex a tone with data, e.g., for a second uplink transmission. Based on the determination that the second uplink transmission has been enabled to multiplex the tone with the data, the WTRU may determine a tone reservation pattern for the second uplink transmission. The WTRU may be configured with the tone reservation pattern for the second uplink transmission. For example, the WTRU may be configured with the tone reservation pattern by a base station. In examples, the WTRU may determine a tone reservation pattern that may be accommodated by (e.g., does not exceed the number of) the determined available REs for tone reservation.

In examples, the WTRU may determine a target coding rate (e.g., a second target coding rate) based on the first target coding rate and/or the configured coding rate increase (e.g., by multiplying the configured coding rate increase by the first target coding rate). As described herein, the WTRU may determine the number of REs for data transmission using the second target coding rate and/or may determine the number of allocated REs. As described herein, the WTRU may determine available REs for tone reservation based on at least the determined number of REs for data transmission and/or the number of allocated REs.

In examples, the WTRU may transmit a transmission (e.g., a second transmission). The second transmission may be, or may include, data and/or the determined tone reservation pattern. In examples, the data may be transmitted using the REs for data transmission. In examples, the tone reservation pattern may be transmitted using at least one of the available REs for tone reservation.

As illustrations of described herein, the WTRU may send the second uplink transmission. The second uplink transmission may be, or may include, the tone multiplexed with the data in accordance with the tone reservation pattern.

As described herein, the second uplink transmission may be, or may include, a data transmission and a tone reservation. The WTRU may determine a number of REs associated with the data transmission and/or a number of REs associated with the tone transmission based on the number of allocated REs. The WTRU may perform the data transmission using the number of REs associated with the data transmission. The WTRU may perform the tone transmission using the number of REs associated with the tone transmission.

In examples, the WTRU may determine the number of REs to be use for the tone reservation transmission based on the configured coding rate increase. The coding rate increase may be configured. For example, the WTRU may be configured with a coding rate increase (e.g., if the tone is to be multiplexed for an uplink retransmission). For example, a coding rate increase may be represented in a percentage (e.g., 10%). In examples, the coding rate increase may be associated with a percentage of the first target coding rate. The second target coding rate associated with the second uplink transmission may be determined based on the coding rate increase and the first target coding rate.

In examples, a WTRU may determine one or more TR resources for one or more slot transmissions.

A WTRU may be configured with an association between a repetition number/slot index for transport block over multi-slot (TBoMS) and puncturing pattern/number of resources for rate matching for tone reservation multiplexing. For example, the WTRU may receive configuration information. The configuration information may indicate a puncturing pattern associated with an uplink transmission.

The WTRU may receive a grant (e.g., a multi-slot grant) to transmit one or more PUSCH repetitions and/or TBs over one or more slots. For PUSCH, the WTRU may determine the puncturing pattern/number of resources for rate matching, for example, based on repetition number/slot index for TboMS within the slot transmission. For example, the WTRU may receive an uplink grant. The uplink grant may be associated with the uplink transmission.

As illustrations of described herein, based on the configuration information and the uplink grant, the WTRU may apply the puncturing pattern to a slot that is associated with the uplink transmission. The puncturing pattern may further be associated with multiplexing a tone with data for the uplink transmission. In examples, the WTRU may be configured (e.g., preconfigured) with an association between a repetition number/slot index and a puncturing pattern for the uplink grant, and/or an association between a repetition number/slot index and a percentage of uplink grant resources that may be used for tone reservation.

As illustrations of described herein, the uplink grant may include a DCI. The WTRU may determine the puncturing pattern based on at least one of a slot index associated with a multi-slot transmission for the uplink transmission, a pattern indicated in the DCI, a configured redundancy version, or a repetition number of slots associated with the uplink transmission.

The puncturing pattern described herein may indicate one or more REs to be punctured for the uplink transmission. In examples, the WTRU may determine the puncturing pattern based on the DCI. The puncturing pattern may be configured to be applied to the slot for a multi slot transmission associated with the uplink transmission.

In examples, the WTRU may determine the first puncturing pattern and a second puncturing pattern based on the DCI. The first puncturing pattern may be configured to apply to a first group of slots for a multi-slot transmission associated with the uplink transmission. The second puncturing pattern may be configured to apply to a second group of slots for the multi-slot transmission associated with the uplink transmission.

The WTRU may be scheduled with an uplink grant on one or more slots. A base station, such as a gNB, may indicate a number of repetitions and/or a number of slots for PUSCH transmission.

The WTRU may apply on a slot a puncturing pattern and/or a number of resources to use for tone reservation, for example, based on the repetition number/slot index.

As described herein, the WTRU may multiplex the tone (e.g., tone reservation signal) with data transmission (e.g., that are associated with the uplink transmission) with the selected TR multiplexing scheme, e.g., the puncturing pattern.

In examples, the WTRU may transmit the tone (e.g., the TR signal) multiplexed with the data for a PUSCH transmission. For example, the uplink transmission described herein may be associated with a PUSCH transmission.

The TR resources described herein may be time resources and/or frequency resources used to transmit a tone (e.g., tone reservation signal), for example, to reduce the PAPR of a signal.

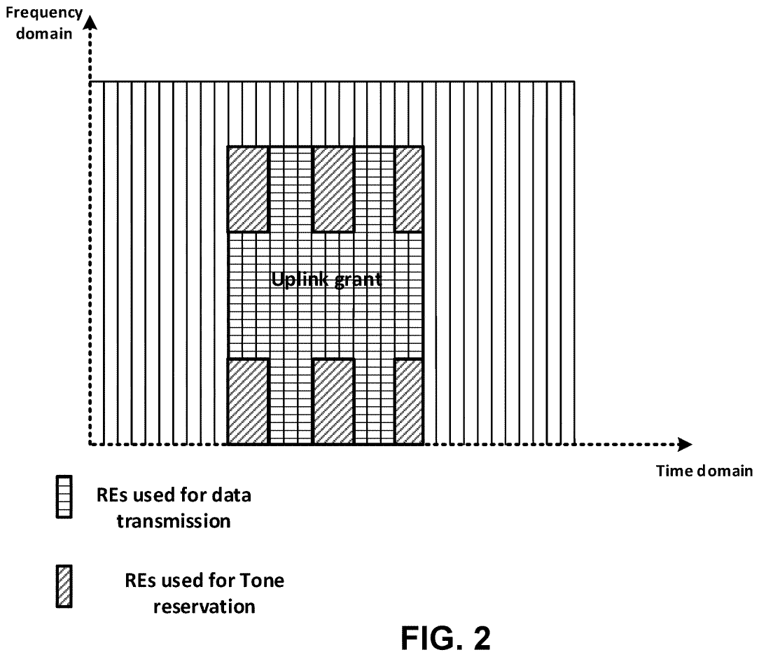

The TR pattern described herein may be a pattern of TR resources for multiplexing a tone (e.g., tone reservation signal) with an uplink data transmission, e.g., for an uplink transmission. For example, FIG. 2 illustrates an example TR pattern. As illustrated in FIG. 2, one or more uplink grant resources may be used for tone transmission (e.g., transmitting a tone/tone reservation signal) in a location (e.g., a specific location). One or more remaining resources of the uplink grant may be used for data transmission. The WTRU may be configured with one or multiple TR patterns that may be used if data transmission is multiplexed with tone reservation transmission (e.g., tone and/or TR signal). A TR pattern may be, or may include, a frequency domain resource and/or a time domain resource to use for tone reservation transmission, e.g., from a scheduled uplink grant. In examples, TR pattern configuration may be, or may include, a symbol (e.g., a first symbol) to use for TR transmission (e.g., a tone and/or a TR signal), length, and/or periodicity in a time domain. For example, a symbol (e.g., a first symbol) of a scheduled grant and/or three symbols length and periodicity of three symbols may be configured as illustrated in FIG. 2. In examples, for a frequency domain, TR pattern configuration may be, or may include, an RE (e.g., a first RE) to use for tone reservation transmission (e.g., a tone and/or TR signal) and/or number of REs and periodicity in a frequency domain within a symbol. In examples, TR pattern may be based on (e.g., depend on) the RB allocation for the uplink grant.

A multiplexing scheme between TR and data transmission may be, or may include, using one or more uplink grant resources to provide resources for tone reservation transmission (e.g., tone and/or TR signal), for example, using puncturing or rate matching. The WTRU, using a multiplexing scheme, may use a TR pattern described herein. One or more resources (e.g., the one or more remaining resources) from the uplink grant, if TR pattern may be applied, may be used to puncture and/or rate match the uplink data transmission.

A tone reservation multiplexing scheme may be based on transmit power. For example, one or more power ranges may be associated with one or more TR multiplexing schemes.

In examples, a WTRU may receive a configuration and/or configuration information from a base station, such as a gNB. The configuration/configuration information may indicate an association between a transmit power range and a multiplexing scheme of TR and an uplink grant transmission. The configuration/configuration information may be, or may include, one or more power ranges, such as a first power range, a second power range, a third power range, a fourth power range, and/or a fifth power range.

A first power range may be associated with the uplink data transmission. For example, the first power range may be associated with performing the uplink transmission with uplink data transmission. In examples, the first power range may perform the uplink transmission without multiplexing tone transmission, such as tone and/or TR signal. In examples, a first power range may be, or may include, [P0, P1]. For example, for a transmit power within the range [P0, P1], the WTRU may transmit an uplink grant without tone reservation (e.g., tone, TR signal, and/or TR transmission).

A second power range may be associated with a puncturing pattern (e.g., a first puncturing pattern) to multiplex tone (e.g., TR signal) with the uplink data transmission. In examples, a second power range may be, or may include, [P1, P2]. For example, for a transmit power within the range [P1, P2], the WTRU may transmit the uplink grant by multiplexing data transmission with tone reservation transmission (e.g., tone and/or TR signal) using a puncturing pattern (e.g., a first puncturing pattern).

A third power range may be associated with a puncturing pattern (e.g., a second puncturing pattern) to multiplex tone (e.g., TR signal) with the uplink data transmission. In examples, a third power range may be, or may include, [P2, P3]. For example, for a transmit power within the range [P2, P3], the WTRU may transmit the uplink grant by multiplexing data transmission with tone reservation transmission (e.g., tone and/or TR signal) using a puncturing pattern (e.g., a second puncturing pattern).

A fourth power range may be associated with a number of REs (e.g., a first number of REs) to multiplex tone (e.g., TR signal) with the uplink data transmission, for example, using rate matching. In examples, a fourth power range may be, or may include, [P3, P4]. For example, for a transmit power within the range [P3, P4], the WTRU may transmit the uplink grant by multiplexing data transmission with tone reservation transmission (e.g., tone and/or TR signal) using rate matching. The WTRU may use the number of RES (e.g., the first number of REs) for tone reservation transmission (e.g., tone and/or TR signal) and one or more resources (e.g., one or more remaining resources) of the uplink grant for data transmission.

A fifth power range may be associated with a number of REs (e.g., a second number of REs) to multiplex tone (e.g., TR signal) with the uplink data transmission using rate matching. In examples, a fifth power range may be, or may include, [P4, P5]. For example, for a transmit power within the range [P4, P5], the WTRU may transmit the uplink grant by multiplexing data transmission with tone reservation transmission (e.g., tone and/or TR signal) using rate matching. The WTRU may use the number of RES (e.g., the second number of REs) for tone reservation transmission (e.g., tone and/or TR signal) and one or more resources (e.g., one or more remaining resources) of the uplink grant for data transmission.

Transmission power may be based on (e.g., depend on) a TR multiplexing scheme. If a WTRU calculates a transmission power (e.g., the required transmission power) of PUSCH transmission with tone reservation transmission (e.g., tone and/or TR signal), the WTRU may exclude, in the calculation of a number of resource elements carrying PUSCH symbols, one or more resource elements, and/or one or more subcarriers that carry tones for tone reservation transmission. The WTRU may receive configuration and/or configuration information, for example, by higher layer signaling, for an adjustment factor to apply to the power transmission (e.g., the required transmission power in dB) for a tone reservation scheme.

As described herein, the transmission power may be calculated based on an assumption that the WTRU uses a reference and/or a default tone reservation scheme. For example, the reference and/or the default tone reservation scheme may be that there is no tone reservation transmission (e.g., tone and/or TR signal).

One or more references for transmission power range may be provided. For example, a WTRU may receive configuration and/or configuration information for a transmit power value (e.g., P1, P2, and/or the like) based on at least one of the following: an absolute value (e.g., in dBm units); an offset (e.g., in dB units) relative to the maximum transmission power of the WTRU according to the power class; and/or an offset (e.g., in dB units) relative to the configured maximum transmission power applicable to the transmission (e.g., Pcmax,c).

A TR multiplexing scheme may be based on transmission power improvement (TPI) and/or power headroom improvement. In examples, a WTRU may determine a TPI applicable to at least one TR multiplexing schemes. The WTRU may select a TR multiplexing scheme or a scheme without TR multiplexing based on the transmission power improvement and one or more examples described herein.

In examples, the WTRU may determine a configured maximum transmission power (Pcmax,c) for a TR multiplexing scheme. For example, a maximum transmission power (e.g., Pcmax,c) may be configured and/or calculated using one or more schemes used (e.g., used in one or more fourth generation (4G) long term evolution (LTE) schemes and/or one or more fifth generation (5G) new radio (NR) schemes) and/or assuming that the transmission uses the TR multiplexing scheme.

In examples, the WTRU may determine a power headroom (PHₙ) applicable to a TR multiplexing scheme, using the one or more schemes used (e.g., used in one or more 4G LTE schemes and/or one or more 5G NR schemes) but using the value of maximum transmission power (e.g., Pcmax,c) determined for the TR multiplexing scheme. The WTRU may include one or more potential adjustments of transmission power (e.g., required transmission power) caused by applying the TR multiplexing scheme.

In examples, WTRU may select a TR multiplexing scheme based on maximizing power headroom. In examples, the WTRU may select a TR multiplexing scheme that maximizes the resulting power headroom (PHₙ). For example, if more than one TR multiplexing scheme results in a positive PHₙ, the WTRU may select a TR scheme that minimizes the ratio of resources used for tone reservation among more than one TR schemes.

In examples, WTRU may select a TR multiplexing scheme based on potential transmission power improvement. In examples, the WTRU may determine a potential transmission power (P_{TR,n}) with the TR multiplexing scheme #n, for example, as the minimum value between the Pcmax,c applicable for the scheme and the transmission power determined by the WTRU before limitation by Pcmax,c. The transmission power may be expressed by:

P_{TR,n}=Pcmax,c−max(PHₙ,0).

The potential transmission power improvement (TPIₙ) of a TR multiplexing scheme may be defined as the difference between the potential transmission power applicable to the scheme, and the potential transmission power applicable to a reference, and/or a default scheme. For example, the reference scheme may skip applying (e.g., not applying) a tone reservation.

The WTRU may receive a configuration for a minimum potential transmission power improvement (TPI_{min,n}) for a TR multiplexing scheme. The WTRU may select a TR multiplexing scheme if the resulting TPIₙ may be higher than the minimum TPI_{min,n} for the scheme. If more than one TR multiplexing schemes have been selected (e.g., more than one TR multiplexing scheme have been selected if the resulting TPIₙ is higher than the minimum TPI_{min,n} for the scheme), the WTRU may select the TR multiplexing scheme for which the difference between the potential transmission power improvement and the minimum may be the highest. Additionally and/or alternatively, the WTRU may select the TR multiplexing scheme for which the potential transmission power improvement may be high (e.g., the highest). The configuration of minimum potential transmission power improvement may be provided for a maximum tone reservation ratio, for example, corresponding to the fraction of resources used for tone reservation.

In examples, the WTRU may determine TPIₙ based on the potential applicable transmission power. For example, the WTRU may determine TPIₙ based on the potential transmission power applicable after transmission power reduction caused by power allocation within a cell group and/or across a cell group.

A WTRU may determine an uplink grant and/or transmit power. The WTRU may receive a DCI scheduling an uplink grant. The WTRU may determine the transmit power to apply for the scheduled uplink grant, for example, using a power control formula.

In examples, the WTRU may be configured with carrier aggregation and/or dual connectivity and may have one or more (e.g., multiple) grants on a carrier. The WTRU may determine, for a carrier, the transmit power. In examples, the Pcmax may be reduced (e.g., not due to PAPR limitation) if the WTRU is not allowed to use TR multiplexing with data transmission.

A WTRU may determine tone (e.g., TR signal) and/or data multiplexing. In examples, the WTRU may determine a multiplexing scheme between a TR transmission and an uplink data transmission, for example, based on the power range to which the determined transmit power belongs to. The WTRU may use a configuration between the power range and the TR multiplexing scheme. In examples, the WTRU may be indicated with maximum power reduction (MPR) to use for an uplink transmission. Based on the indicated MPR, the WTRU may determine whether to multiplex a tone reservation transmission (e.g., a tone and/or a TR signal) with the uplink data transmission or not to multiplex the tone reservation transmission (e.g., the tone and/or the TR signal) with the uplink data transmission.

A WTRU may indicate a TR multiplexing scheme to a base station, such as a gNB. In examples, the WTRU may indicate to the gNB a multiplexing scheme used to transmit TR transmission (e.g., a tone and/or a TR signal) with data transmission, e.g., for an uplink transmission. For example, the WTRU may be configured to use UCI to indicate to the gNB the multiplexing scheme between TR transmission and data transmission. The UCI may be piggybacked in a scheduled uplink grant on which tone (e.g., TR signal) and/or data multiplexing may be transmitted. One or more resources for UCI may not be used by one or more TR resources and/or use one or more pre-determined time and/or frequency resources. Additionally and/or alternatively, a UCI on a separate PUSCH may be used to transmit an indication of the multiplexing scheme. In examples, a MAC CE on a separate PUSCH may be used to transmit an indication of the multiplexing scheme (e.g., UCI and/or MAC CE). The separate PUSCH may be transmitted, for example, prior to the uplink grant carrying tone reservation.

PUSCH transmission may be, or may include, tone (e.g., TR signal) multiplexed. A WTRU may determine the multiplexing scheme for data transmission and/or one or more TR resources. For example, after the WTRU determines the multiplexing scheme for data transmission and/or one or more TR resources, the WTRU may transmit the uplink grant PUSCH using a number of REs (e.g., a first number of REs) for tone reservation and a number of REs (e.g., a second number of REs) for uplink data transmission. For example, the number of REs (e.g., the first and/or the second number of REs) may be determined according to the selected multiplexing scheme as described herein.

A WTRU may transmit a power headroom report (PHR). For example, the WTRU may transmit PHR after an uplink data transmission multiplexing with a TR transmission. In examples, the WTRU may transmit PHR to a base station, such as a gNB, after transmitting PUSCH with a tone reservation transmission (e.g., a tone and/or TR signal) multiplexed with an uplink data transmission. The PHR report may have one or more (e.g., two) reports. For example, a first report may be calculated using the transmitted power uplink with tone reservation multiplexed (e.g., higher transmit power). For example, a second report may be calculated using the transmitted power uplink without tone reservation multiplexed.

FIG. 3 illustrates an example flow diagram of a tone reservation multiplexing scheme based on a transmit power as described herein. As illustrated in FIG. 3, a WTRU may receive configuration and/or configuration information from a base station. For example, a WTRU may receive configuration and/or configuration information from a gNB. The configuration/configuration information may associate and/or indicate an association with a transmit power range with a multiplexing scheme of TR transmission (e.g., a tone and/or TR signal) and an uplink data transmission. The configuration information may be configured for a period of time or a number of uplink grants as described herein.

A first power range may be associated with an uplink data transmission (e.g., data without a tone reservation, for example data without a multiplexing tone). For example, a first power range may be, or may include, [P0, P1]. As described herein, a second power range may be associated with a puncturing pattern (e.g., a first puncturing pattern) to multiplex a TR transmission with an uplink data transmission. For example, a second power range may be, or may include, [P1, P2]. As described herein, a third power range may be associated with a puncturing pattern (e.g., a second puncturing pattern) to multiplex a TR transmission with an uplink data transmission. For example, a third power range may be, or may include, [P2, P3]. As described herein, a fourth power range may be associated with a number of REs (e.g., a first number of REs) to use for a TR transmission with an uplink data transmission and/or rate match the data transmission on one or more REs (e.g., one or more remaining REs) of the uplink grant. For example, a fourth power range may be, or may include, [P3, P4]. As described herein, a fifth power range may be associated with a number of REs (e.g., a second number of REs) to use for a TR transmission with an uplink data transmission and/or rate match the data transmission on one or more REs (e.g., one or more remaining REs) of the uplink grant. For example, a fifth power range may be, or may include, [P4, P5]. In examples, the first puncturing pattern described herein may differ from the second puncturing pattern. In examples, the first number of REs may differ from the second number of REs.

As illustrated in FIG. 3, the WTRU may receive an uplink grant. The uplink grant may be associated with an uplink transmission. For example, the uplink transmission may be associated with performing an uplink data transmission and/or multiplexing the uplink data transmission with a TR transmission (e.g., a tone and/or TR signal) as described herein to perform an uplink transmission.

As illustrated in FIG. 3, the WTRU may determine the transmit power, e.g., to use for the uplink grant. As illustrations of described herein, the WTRU may determine that the transmit power is in a transmit power range. The transmit power range may be one or more transmit power ranges described herein. In examples, the transmit power range may be the first transmit power range or the second power range described herein. In examples, the transmit power range may be the second transmit power range or the third power range described herein. In examples, the transmit power range may be the fourth transmit power range or the fifth power range described herein.

As illustrations of described herein, in examples, the determined transmit power range may be the first transmit power range and the determined multiplexing scheme may be the first multiplexing scheme. In examples, the determined transmit power range may be the second transmit power range and the determined multiplexing scheme may be the second multiplexing scheme.

As illustrated in FIG. 3, the WTRU may determine the multiplexing scheme. The multiplexing scheme is associated with one or more multiplexing schemes described herein. For example, the multiplexing scheme may be a first multiplexing scheme or a second multiplexing scheme. The multiplexing scheme may multiplex between the TR transmission (e.g., the tone and/or TR signal) and the uplink data transmission. For example, based on the power range to which the determined transmit power belongs, the WTRU may determine the multiplexing scheme associated with the uplink transmission. In examples, the WTRU may indicate to the base station, such as the gNB, the multiplexing scheme used to transmit the TR transmission with the data transmission (e.g., UCI and/or MAC CE). The UCI may be piggybacked in the PUSCH transmission carrying the tone (e.g., the TR signal). A MAC CE may be transmitted before the PUSCH transmission carrying TR.

As illustrated in FIG. 3, the WTRU may transmit the TR transmission (e.g., the tone and/or the TR signal) multiplexed with PUSCH transmission. As described herein, the tone that is being multiplexed with the data may be associated with a TR signal. For example, the WTRU may send the uplink transmission. The uplink transmission may be, or may include, the TR transmission multiplexed with the data transmission. The WTRU may send the tone (e.g., the TR signal) with the data in accordance with the determined multiplexing scheme (e.g., the first multiplexing scheme, the second multiplexing scheme, and so on). For example, the WTRU may configure to send the tone (e.g., the TR signal) multiplexed with the data in accordance with the determined multiplexing scheme.

In examples, a WTRU may enable rate matching for a transmission (e.g., an initial transmission) with TR. As described herein, a WTRU may receive configuration information. The configuration information may be, or may include, a target TBS reduction configuration and/or a target reduction information. The target reduction information may be associated with a target reduction. For example, the target reduction information may provide a target TBS reduction value associated with a percentage or a number of bits that is to be subtracted from a TBS value.

The WTRU may be configured with target TBS reduction to be applied if tone reservation is determined to be used and/or a TR transmission is to be multiplexed with an uplink data transmission. The configured target TBS reduction may indicate how much TBS may be reduced to allow one or more TR resources to be multiplexed within one or more uplink grant resources. In examples, a target TBS reduction may be a reduction percentage to be applied by the WTRU to the TBS calculated for a scheduled uplink grant if one or more TR resources are to be multiplexed with the uplink transmission. For example, if the target TBS reduction is equal to 10%, the TBS may be multiplied by 90%, for example, to allow one or more TR resources to be multiplexed with data transmission (e.g., uplink data transmission). In examples, the target TBS reduction may be a number of bits that may be subtracted by the WTRU from a TBS value if one or more TR resources are to be multiplexed with the uplink transmission. For example, if the target TBS reduction is 10 bits, 10 bits may be removed from the TBS, for example, to allow one or more TR resources to be multiplexed with data transmission (e.g., uplink data transmission).

In examples, the WTRU may receive an uplink grant for a transmission (e.g., an initial transmission). In examples, the WTRU may receive a DCI scheduling an uplink grant. The DCI may carry an NDI and/or a HARQ process ID for the scheduled uplink grant. The WTRU may determine that the NDI may be toggled for the scheduled HARQ process ID. The WTRU may determine that the scheduled uplink transmission is an initial transmission. In examples, the WTRU may be configured with a configured grant uplink transmission. For example, the WTRU may determine (e.g., autonomously determine) whether the configured uplink grant may be used for a transmission (e.g., an initial transmission) or retransmission.

In examples, the WTRU may enable multiplexing tone reservations with an uplink grant. For example, the WTRU may receive an uplink grant. After receiving an uplink grant, the WTRU may determine whether to enable multiplexing one or more TR resources with an uplink transmission, such as an uplink grant transmission. In examples, the WTRU may be indicated by a base station, such as a gNB, to multiplex one or more TR resources, for example, using the scheduling DCI. For example, a bitfield may be indicated to the WTRU to multiplex one or more TR resources with an uplink grant transmission. In examples, the WTRU may determine to multiplex one or more TR resources with a property of (e.g., a property of uplink resource) a scheduled uplink grant, such as a pre-configured RB allocation, that may be associated with TR multiplexing. The WTRU may receive a configuration that indicates one or more different uplink resource allocations. For example, the configuration may indicate whether one or more TR resources are multiplexed with the uplink resource allocation. In examples, the WTRU may enable multiplexing one or more TR resources if the uplink transmit power is above a threshold (e.g., a configured threshold).

In examples, the WTRU may determine a TBS. For example, the WTRU may calculate the TBS after enabling the multiplexing of one or more TR resources with one or more uplink grant resources. The WTRU may use the indicated MCS (I_{mcs}) in DCI, scheduling an uplink grant and/or the total number of allocated RBs by the scheduling DCI. The indicated I_{mcs} may point to a row of a pre-configured MCS table (e.g., one of a pre-configured MCS tables). For example, the indicated I_{mcs} may point to a row of a pre-configured MCS table and may indicate a modulation order and/or target coding rate to use for an uplink grant transmission. The WTRU may determine the number of REs available for an uplink grant, for example, by calculating the total allocated REs within the slot and/or removing one or more REs used for DMRS and one or more REs used as overhead. The number of REs available

$${N}_{R E}^{available}$$

in a scheduled uplink grant may be multiplied by the modulation order and/or the target coding rate, for example, to calculate an unquantized number of information

$${N}_{info} = {N}_{R E}^{available} \times {Q}_{m} \times R .$$

R may be the target coding rate determined using the I_{mcs} indication in the DCI. Qₘ may be the modulation order determined using the I_{mcs} indication in the DCI. The WTRU may determine the TBS using one of the following: quantizing the unquantized number of information N_{info} using a preconfigured quantized function to obtain N′_{info}; reducing the unquantized number of information N_{info} by a configured ratio and/or a number of bits; and/or quantizing the unquantized number of information N_{info} using a preconfigured quantized function to obtain N′_{info}.

In examples, the unquantized number of information N_{info} may be quantized using a preconfigured quantized function to obtain N′_{info}. The WTRU may determine an intermediate TBS. For example, the WTRU may determine an intermediate TBS by finding the closest TBS (e.g., closest from preconfigured TBS values) to N′_{info}. The intermediate TBS may be reduced, for example, using the configured target TBS reduction. For example, if a target TBS reduction is a reduction percentage equals to r, the intermediate TBS may be multiplied by (1−r) to obtain the TBS. For example, TBS=(1−r) x intermediate TBS. In examples, if a target TBS reduction is a number of bits that may be subtracted from intermediate TBS, the TBS may be calculated by subtracting the target TBS reduction from the intermediate TBS. For example, TBS=intermediate TBS-target TBS reduction.

In examples, the unquantized number of information N_{info} may be reduced by a configured ratio and/or a number of bits. The configuration of ratio and/or the number of bits may be configured by an RRC signaling. The reduced N_{info}, N^{r}_{info} may be quantized using a preconfigured quantized function to obtain N′_{info}. The WTRU may determine the TBS by finding the closest TBS (e.g., the closest TBS from preconfigured TBS values) to N′_{info}.

In examples, the unquantized number of information N_{info} may be quantized using a preconfigured quantized function to obtain N′_{info}. The quantized N′_{info} may be reduced by a configured ratio and/or a number of bits. The configuration of ratio and/or the number of bits may be configured by an RRC signaling. The reduced N′_{info}, N′^{r}_{info}, may be used by the WTRU, for example, to determine the TBS by finding the closest TBS (e.g., the closest TBS from preconfigured TBS values) to N′^{r}_{info}.

In examples, the WTRU may determine a number of REs for data transmission. For example, the WTRU may determine a number of REs for data transmission using the calculated TBS described herein. Using the indicated modulation and/or target coding rate, the WTRU may select the number of REs from the scheduled uplink grant to transmit with the determined TBS. With the target TBS reduction applied, fewer REs may be used from the scheduled REs (e.g., total scheduled REs) in the scheduled uplink grant. The WTRU may calculate the number of REs for data transmission using the following formula.

$${N}_{R E}^{data} = \frac{TBS}{R \times {Q}_{m}} .$$

The TBS may be the TBS obtained as described herein (e.g., quantizing the unquantized number of information N_{info} using a preconfigured quantized function to obtain N′_{info}; reducing the unquantized number of information N_{info} by a configured ratio and/or a number of bits; and/or quantizing the unquantized number of information N_{info} using a preconfigured quantized function to obtain N′_{info}). R may be the target coding rate determined using the I_{mcs} indication in the DCI. Qₘ may be the modulation order determined using the I_{mcs} indication in the DCI.

In examples, the WTRU may determine a number of REs for TR transmission. For example, the WTRU may determine a number of REs for one or more TR resources to be multiplexed within a scheduled uplink grant, for example, using the REs determined for data transmission. The WTRU may calculate the number of REs from the scheduled uplink grant to use for data transmission as described herein. The WTRU may calculate one or more REs (e.g., one or more remaining REs) from the scheduled uplink grant and use the REs for one or more TR resources. For example, the WTRU may calculate TBS using the target TBS reduction and determine the REs to use for uplink data transmission

$${N}_{R E}^{data} = \frac{T B S}{R \times {Q}_{m}} .$$

The TBS may be the reduced TBS. R may be the target coding rate. Qₘ may be the modulation order. The WTRU may calculate the number of TR resources

$${N}_{R E}^{TR}$$

to be multiplexed withing the scheduled uplink grant

$${N}_{R E}^{TR} = {N}_{R E}^{available} - {N}_{R E}^{data} .$$

PUSCH transmission may be TR multiplexed. A WTRU may determine a number of REs for data transmission and/or a number of REs for tone reservation resources. For example, after determining the number of REs for data transmission and the number of REs for tone reservation resources, the WTRU may use

$${N}_{R E}^{TR}$$

REs to transmit tone reservation and use

$${N}_{R E}^{data}$$

to transmit uplink data. The WTRU transmit PUSCH using

$${N}_{R E}^{TR} + {N}_{R E}^{data}$$

number of REs.

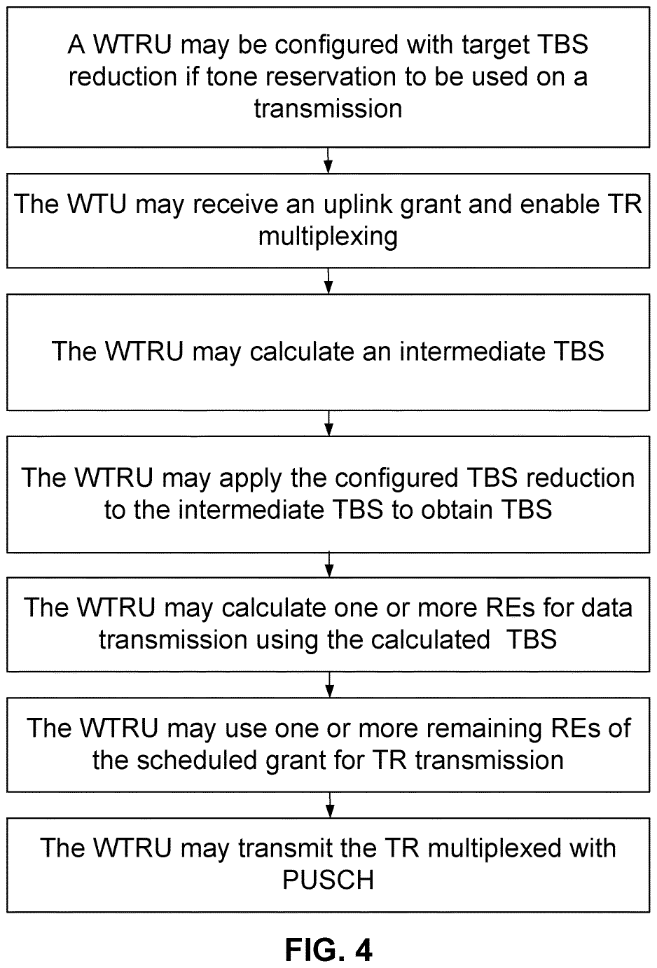

FIG. 4 illustrates an example flow diagram enabling rate matching for a transmission with TR. As illustrated in FIG. 4 and as illustrations of described herein, a WTRU may receive configuration information from a base station, such as a gNB. The configuration information may be, or may include, target transport block size (TBS) reduction information. The TBS reduction information may be, or may include, a target TBS reduction (e.g., a target TBS reduction value). The target reduction value may be associated with a percentage and/or a number of bits that is to be subtracted from a TBS value as described herein. In examples, the WTRU may be configured with a target TBS reduction if tone reservation is to be used on a transmission (e.g., an initial transmission). For example, the target TBS reduction may indicate how much a calculated TBS may be reduced. In examples, a target TBS reduction may be a percentage (e.g., 10%). In examples, a target TBS reduction may be a number of bits that may be subtracted from a TBS value.

As illustrated in FIG. 4, the WTRU may receive an uplink grant. The uplink grant may be associated with an initial uplink transmission. For example, the uplink grant may be, or may include, an NDI. The NDI may be toggled for a HARQ process ID. Based on the NDI and/or the toggled HARQ process ID, the WTRU may determine that the transmission is associated with an initial transmission.

As illustrated in FIG. 4, the WTRU may enable multiplexing tone reservation (e.g., a tone, TR signal, and/or a TR transmission) with the uplink grant. For example, based on the determination that the uplink transmission is associated with the initial uplink transmission, the WTRU may enable multiplexing a tone (e.g., TR signal) with data for the initial uplink transmission.

As illustrated in FIG. 4, the WTRU may calculate the TBS. For example, as described herein, based on the determination that the uplink transmission has been enabled to multiplex the tone with the data, the WTRU may calculate the TBS. The WTRU may determine/calculate the TBS value based on and/or using the indicated MCS and/or the one or more available REs. For example, based on the number of allocated REs in the scheduled uplink grant and/or by excluding one or more overhead REs, the WTRU may determine one or more available REs (e.g., a number of available REs). As described herein, the WTRU may apply TBS reduction to the TBS value. For example, the WTRU may subtract the target TBS reduction from the TBS value.

As illustrated in FIG. 4, the WTRU may determine the number of REs for data transmission, for example, using the calculated TBS.

As illustrated in FIG. 4, the WTRU may use one or more remaining REs of the scheduled uplink grant for tone reservation transmission (e.g., multiplexing a tone and/or tone signal). For example, based on the number of REs associated with data/data transmission, the WTRU may determine a number of RES associated with the tone transmission. The WTRU may send the tone transmission using the number of REs associated with the tone transmission and may send the data transmission using the number of RES associated with the data transmission.

As illustrated in FIG. 4, the WTRU may perform a PUSCH transmission. For example, the WTRU may transmit may perform a PUSCH transmission using the number of REs associated with the tone transmission and the number of REs associated with the data transmission. As described herein, the tone transmission may be multiplexed with the data transmission. In examples, the WTRU may multiplex the tone (e.g., the TR signal) for the TR transmission with PUSCH transmission.

In examples, a WTRU may enable rate matching for retransmission with TR. A WTRU may be configured with a coding rate increase. For example, the WTRU may receive configuration information from a base station. The configuration information may be associated with a coding rate increase. The coding rate increase is associated with a percentage of the first target coding rate. In examples, the WTRU may be configured with a coding rate increase to be applied if a tone (e.g., tone reservation signal) is determined to be used and/or multiplexed with an uplink data transmission. In examples, the coding rate increase may be applied to retransmission, such as a retransmission of an uplink transmission. In examples, the coding rate increase may be applied to a transmission (e.g., an initial transmission). The configured coding rate increase may allow less resource(s) for the data transmission. For example, the configured coding rate increase may allow one or more TR resources to be multiplexed within one or more uplink grant resources. In examples, a coding rate increase may be a percentage to be applied by the WTRU for a target coding rate used in an uplink transmission (e.g., an initial uplink transmission). For example, if the coding increase is equal to 110%, the target coding rate of a transmission (e.g., an initial transmission) may be multiplied by 1.1, for example, to allow one or more TR resources to be multiplexed with data transmission. As described herein, a parameter a may be used to refer to the configured coding rate increase.

In examples, the WTRU may receive an uplink grant for a transmission (e.g., a first transmission). For example, the WTRU may receive a first uplink grant. The first uplink grant may be associated with a first downlink control information (DCI). The first DCI may be associated with a first transmission. In examples, the WTRU may receive a DCI (e.g., a first DCI) scheduling a transmission (e.g., a first transmission). For example, the first transmission may be, or may include, an indication for new data. The first DCI may be, or may include, comprises an NDI associated with the first uplink grant has been toggled for a HARQ process ID. The WTRU may receive a first DCI scheduling a first HARQ process. The first transmission may be used for a data transmission (e.g., data transmission without TR transmission, for example data transmission without multiplexing tone). For example, if the DCI carries NDI that has been toggled for the scheduled HARQ process ID, the WTRU may determine that the first uplink transmission is associated with an initial transmission. The WTRU may assume that the first uplink transmission is associated with a data transmission (e.g., a new data transmission).

The WTRU may use the DCI (e.g., the first DCI) to determine a modulation order (e.g., a first modulation order) and/or a target coding rate for the transmission (e.g., a first target coding rate for the first transmission). In examples, the WTRU may be configured with a configured grant uplink transmission. The WTRU may determine (e.g., autonomously determine) whether the configured uplink grant may be used for a transmission (e.g., an initial transmission) or retransmission and use a pre-configured modulation order and/or a target coding rate for the transmission (e.g., the initial transmission).

As illustrations of described herein, the WTRU may transmit the first transmission, for example, based on the first DCI. For example, the WTRU may send the first uplink transmission based on the first modulation order and the first target coding rate. In examples, the WTRU may transmit a PUSCH transmission based on the modulation order and/or the target coding rate. For example, the WTRU may transmit a first PUSCH transmission based on the first modulation order and/or the first target coding rate.

The WTRU may receive a second uplink grant. In examples, the WTRU may receive an uplink grant for a transmission (e.g., a second transmission). As illustrations of described herein, the second uplink grant may be associated with a second DCI. The second uplink grant may indicate that the second uplink transmission associated with the second uplink grant is a retransmission of the first uplink transmission. In examples, the WTRU may receive a second DCI that may be associated with the second transmission. The second transmission may be a retransmission of the first uplink transmission.

In examples, the WTRU may also receive a DCI (e.g., a second DCI) scheduling a transmission (e.g., a second transmission) for a HARQ process. For example, the WTRU may receive a DCI (e.g., a first DCI) scheduling a transmission (e.g., a first transmission). A base station, such as a gNB, may schedule a retransmission and send a DCI (e.g., a second DCI) to allocate one or more uplink resources for the retransmission of the same HARQ process in the transmission (e.g., the second transmission). The WTRU may receive a DCI (e.g., a second DCI) indicating the number of allocated REs

$${N}_{R E}^{available}$$

for the transmission (e.g., the second transmission). For example, a frequency domain resource allocation (FDRA) may indicate the number of REs to use for the transmission (e.g., the second transmission). In examples, the RRC configuration may indicate the number of allocated REs for configured grant transmission.

As illustrations of described herein, based on the second DCI and/or the second uplink grant, the WTRU may determine a second target coding rate to be used for a second uplink transmission and a number of allocated resource elements (REs).

The WTRU may determine that the second uplink transmission has been enabled to multiplex a tone with data (e.g., multiplexing a TR transmission with a data transmission, where the transmissions are associated with a second uplink grant). For example, the WTRU may receive an uplink grant. After receiving an uplink grant, the WTRU may determine whether to enable multiplexing one or more TR resources with an uplink grant transmission. In examples, the WTRU may be indicated by a base station (e.g., a gNB) to multiplex one or more TR resources using the scheduling DCI. For example, a bitfield may indicate to the WTRU to multiplex one or more TR resources with an uplink grant transmission. In examples, the WTRU may determine to multiplex one or more TR resources with the uplink grant based on a property of (e.g., property of an uplink resource) a scheduled uplink grant, such as a pre-configured RB allocation, that may be associated with TR multiplexing. The WTRU may receive a configuration that indicates for different uplink resource allocation whether one or more TR resources may be multiplexed with the uplink resource allocation. In examples, the WTRU may enable multiplexing one or more TR resources if the uplink transmit power may be above a threshold (e.g., a configured threshold).

As illustrations of described herein, the WTRU may determine a second target coding rate based on the first target coding rate and the configured rate increase. For example, the WTRU may determine the second target coding rate associated with the second uplink transmission based on the coding rate increase and the first target coding rate. In examples, the WTRU may determine a target coding rate for a transmission (e.g., a second transmission). The WTRU may determine a target coding rate (e.g., a second target coding rate) for a transmission (e.g., a second transmission) if the WTRU enables multiplexing a tone (e.g., tone reservation signal) with an uplink grant. For example, the WTRU may determine a second target coding rate based on the first target coding rate and/or the configured coding rate increase. The WTRU may multiply the configured coding rate increase by the first target coding rate, for example, to obtain the second target coding rate. For example, the WTRU may receive a first DCI scheduling a first transmission for a HARQ process and may receive a second DCI scheduling a second transmission (e.g., retransmission) for the same HARQ process. The WTRU may determine the first target coding rate from the first DCI using the indicated MCS (I_{mcs}) in the DCI. The indicated I_{mcs} may point to a row of one of the pre-configured MCS tables to indicate the modulation order and/or the target coding rate to use for the uplink grant transmission. The WTRU may multiply the first target coding rate by the configured coding rate increase to obtain the second target coding rate that may be used for transmitting the second transmission.

Based on the determination that the second uplink transmission has been enabled to multiplex the tone with the data, the WTRU may determine a tone reservation pattern for the second uplink transmission. In examples, the tone reservation pattern for the second uplink transmission may be configured by a base station. In examples, the WTRU may determine one or more REs for data transmission. For example, the WTRU may determine the number of REs for data transmission

$${N}_{R E}^{data}$$

within the transmission (e.g., the second transmission), for example, using the determined second target coding rate and/or the number of allocated REs. For a retransmission, the transport block size may be consistent (e.g., may not be changed). For example, the same information number may be transmitted (e.g., retransmitted) but coded differently. The WTRU may determine the number of REs for data transmission that satisfies the following formula:

$${N}_{R E}^{data} \times {Q}_{m} \times a \times R = {N}_{RE}^{available} \times {Q}_{m} \times R .$$

Qₘ may be the modulation order of the transmission (e.g., the second transmission). α×R may be the target coding rate for the transmission (e.g., the second transmission). R may be the target coding rate for the transmission (e.g., the first transmission). The formula may be simplified to:

$${N}_{R E}^{data} = ⌊ \frac{{N}_{R E}^{available}}{α} ⌋ .$$

a may be the configured coding rate increase (α≥1).

$${N}_{R E}^{available}$$

may be the number of REs available in the scheduled transmission (e.g., the scheduled second transmission).

In examples, the WTRU may determine REs (e.g., a number of REs) for the tone reservation transmission. For example, the WTRU may determine the number of REs for one or more TR resources to be multiplexed within the transmission (e.g., the second transmission) using the REs determined for data transmission. The WTRU may calculate the number of REs for the data transmission as described herein. The WTRU may calculate one or more REs (e.g., one or more remaining REs) from the scheduled transmission (e.g., the scheduled second transmission) and use the REs for the one or more TR resources

$${N}_{R E}^{TR} = {N}_{R E}^{available} - {N}_{R E}^{data} .$$

As illustrations of described herein, in examples, the second uplink transmission may be, or may include, a data transmission and a tone transmission. As described herein, the WTRU may determine the number of allocated REs and/or the number of REs associated with the data transmission. In examples, based on the number of allocated REs, the WTRU may determine a number of REs associated with the data transmission. In examples, based on the number of allocated REs and the number of REs associated with the data transmission, the WTRU may determine a number of REs associated with the tone transmission.

In examples, the WTRU may select a tone reservation pattern. For example, the WTRU may be preconfigured with one or more tone reservation patterns to be used for TR multiplexing with data transmission. A pattern may indicate one or more symbols and/or one or more REs within the symbol in a slot. For example, a pattern may be a matrix with 1 or 0. The number of rows may be equal to the number of REs, and the number of columns may be equal to the number of symbols. After determining the number of REs for one or more TR resources to be multiplexed within the transmission (e.g., the second transmission), the WTRU may determine a tone reservation pattern. In examples, the WTRU may determine the tone reservation pattern for the second uplink transmission from the one or more pre-configured patterns (e.g., configured by a base station as described herein). In examples, the WTRU may determine a tone reservation pattern based on the number of resource elements for the data transmission. For example, the WTRU may select a pattern that does not exceed the number of the determined available REs for tone reservation.

As illustrations of described herein, the WTRU may transmit the second transmission. For example, the WTRU may send the second uplink transmission. The WTRU may multiplex the tone with the data in accordance with the tone reservation pattern. In examples, the WTRU may perform the data transmission using the number of REs associated with the data transmission. In examples, the WTRU may perform the tone transmission using the number of REs associated with the tone transmission.

In examples, the WTRU may transmit the transmission (e.g., the second transmission). For example, after determining the number of REs for data transmission and/or the number of REs for tone reservation resources, the WTRU may use the

$${N}_{R E}^{TR}$$

REs to transmit tone reservation and/or use

$${N}_{R E}^{data}$$

REs to transmit an uplink data. The WTRU may transmit PUSCH using

$${N}_{R E}^{TR} + {N}_{R E}^{data}$$

number of REs. The WTRU may transmit the transmission (e.g., the second transmission). The transmission (e.g., the second transmission) may be, or may include, data and/or the determined tone reservation pattern. In examples, the data may be transmitted using the REs for data transmission. In examples, the tone reservation pattern may be transmitted using one or more available REs for tone reservation.

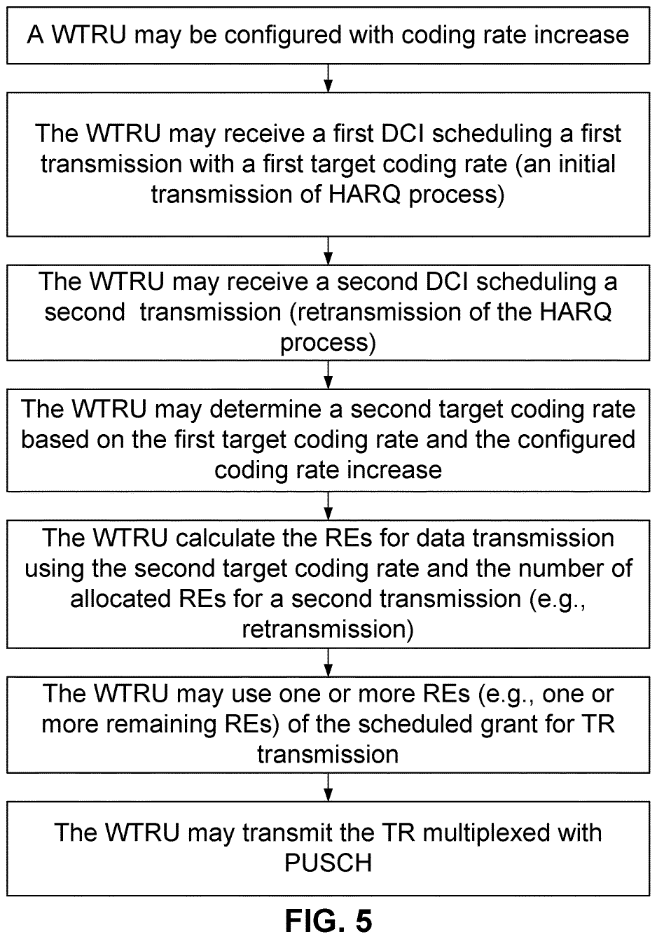

FIG. 5 illustrates an example flow diagram for enabling rate matching for retransmission with TR. As illustrated in FIG. 5, a WTRU may be configured with a coding rate increase (e.g., if tone reservation is to be used for retransmission). As illustrations of described herein, for example, the WTRU may receive configuration information from a base station. The configuration information may be associated with a coding rate increase. The coding rate increase is associated with a percentage of the first target coding rate. In examples, the WTRU may be configured with a coding rate increase to be applied if a tone (e.g., tone reservation signal) is determined to be used and/or multiplexed with an uplink data transmission. In examples, the coding rate increase may be applied to retransmission, such as a retransmission of an uplink transmission. In examples, the coding rate increase may be applied to a transmission (e.g., an initial transmission). The configured coding rate increase may allow less resource(s) for the data transmission. For example, the configured coding rate increase may allow one or more TR resources to be multiplexed within one or more uplink grant resources. In examples, a coding rate increase may be a percentage to be applied by the WTRU for a target coding rate used in an uplink transmission (e.g., an initial uplink transmission). For example, a coding rate increase may be a percentage (e.g., 10%).

As illustrated in FIG. 5, the WTRU may receive a DCI (e.g., a first DCI) scheduling a transmission (e.g., a first transmission). As illustrations of described herein, for example, the WTRU may receive a first uplink grant. The first uplink grant may be associated with a first downlink control information (DCI). The first DCI may be associated with a first transmission. In examples, the WTRU may receive a DCI (e.g., a first DCI) scheduling a transmission (e.g., a first transmission). For example, the first transmission may be, or may include, an indication for new data. The first DCI may be, or may include, comprises an NDI associated with the first uplink grant has been toggled for a HARQ process ID. The WTRU may receive a first DCI scheduling a first HARQ process. The first transmission may be used for a data transmission (e.g., data transmission without TR transmission, for example data transmission without multiplexing tone). For example, if the DCI carries NDI that has been toggled for the scheduled HARQ process ID, the WTRU may determine that the first uplink transmission is associated with an initial transmission. The WTRU may assume that the first uplink transmission is associated with a data transmission (e.g., a new data transmission). In examples, the transmission may be for a HARQ process. In examples, the transmission (e.g., the first transmission) may be for data (e.g., new data). The DCI (e.g., the first DCI) may include information the WTRU uses to determine a modulation order (e.g., a first modulation order) and/or a target coring rage (e.g., first target coding rate).

As illustrated in FIG. 5, the WTRU may transmit the transmission (e.g., first transmission). The WTRU may transmit the first transmission, for example, based on the first DCI. For example, the WTRU may send the first uplink transmission based on the first modulation order and the first target coding rate. For example, the transmission (e.g., the first transmission) may be a PUSCH transmission (e.g., first PUSCH transmission). The transmission may be based on the modulation order (e.g., the first modulation order) and/or the target coding rate (e.g., first target coding rate).

As illustrated in FIG. 5, the WTRU may receive a DCI (e.g., a second DCI) scheduling a transmission (e.g., a second transmission for the HARQ process). The transmission (e.g., the second transmission) may be a retransmission (e.g., of the first transmission). The DCI (e.g., the second DCI) may include information for the WTRU to use to determine a number of allocated REs. As illustrations of described herein, the WTRU may receive a second uplink grant. In examples, the WTRU may receive an uplink grant for a transmission (e.g., a second transmission). The second uplink grant may be associated with a second DCI. The second uplink grant may indicate that the second uplink transmission associated with the second uplink grant is a retransmission of the first uplink transmission. In examples, the WTRU may receive a second DCI that may be associated with the second transmission. The second transmission may be a retransmission of the first uplink transmission.

As illustrated in FIG. 5, the WTRU may determine a modulation order (e.g., a second target coding rate). For example, based on the second DCI and/or the second uplink grant, the WTRU may determine a second target coding rate to be used for a second uplink transmission and a number of allocated REs. The WTRU may determine a modulation order (e.g., a second modulation order) based on the first target coding rate and/or the configured coding rate increase. For example, the WTRU may determine a modulation order (e.g., a second modulation order) by multiplying the configured coding rate increase by the first target coding rate. The WTRU may determine a second target coding rate based on the first target coding rate and the configured rate increase. For example, the WTRU may determine the second target coding rate associated with the second uplink transmission based on the coding rate increase and the first target coding rate. In examples, the WTRU may determine a target coding rate for a transmission (e.g., a second transmission).

As illustrations of described herein, the WTRU may determine that the second uplink transmission has been enabled to multiplex a tone with data (e.g., multiplexing a TR transmission with a data transmission, where the transmissions are associated with a second uplink grant). As described herein, based on the determination that the second uplink transmission has been enabled to multiplex the tone with the data, the WTRU may determine a tone reservation pattern for the second uplink transmission. In examples, the tone reservation pattern for the second uplink transmission may be configured by a base station. In examples, the WTRU may determine one or more REs for data transmission.

As illustrated in FIG. 5, the WTRU may determine a number of REs for data transmission, for example, using the second target coding rate and/or the number of allocated REs.

As illustrated in FIG. 5, the WTRU may determine one or more available REs for a tone reservation transmission, for example, based on at least the determined number of REs for data transmission and the number of allocated REs.

As illustrated in FIG. 5, the WTRU may determine a tone reservation pattern that may be accommodated by (e.g., does not exceed the number of) the determined available REs for tone reservation.

As illustrated in FIG. 5, a WTRU may transmit a transmission (e.g., a second transmission). The transmission (e.g., the second transmission) may be, or may include, data and/or the determined tone reservation pattern. For example, the second uplink transmission may be, or may include, a data transmission and a tone transmission. As described herein, the WTRU may determine the number of allocated REs and/or the number of REs associated with the data transmission. In examples, based on the number of allocated REs, the WTRU may determine a number of REs associated with the data transmission. In examples, based on the number of allocated REs and the number of REs associated with the data transmission, the WTRU may determine a number of REs associated with the tone transmission. In examples, the data may be transmitted using the one or more REs for data transmission. In examples, the tone reservation pattern may be transmitted using at least one of the available REs for tone reservation.

As illustrations of described herein, the WTRU may transmit the second transmission. For example, the WTRU may send the second uplink transmission. The WTRU may multiplex the tone with the data in accordance with the tone reservation pattern. In examples, the WTRU may perform the data transmission using the number of REs associated with the data transmission. In examples, the WTRU may perform the tone transmission using the number of REs associated with the tone transmission.

In examples, a WTRU may determine one or more TR resources for a slot transmission(s).

In examples, a WTRU may be configured with a time domain resource allocation list for PUSCH transmission. The scheduling DCI may indicate an entry from the list where the indicated entry may be used for the scheduled PUSCH. An entry of the time domain resource allocation list may be, or may include, one or more slots, one or more OFDM symbols to use in a slot, a number of slots for transport block (TB) processing and/or a number of repetitions.

In TB processing over one or more slots, a transport block may be transmitted over one or more slots. In a slot, depending on a redundancy version, information and/or one or more parity bits from one or more coded bits may be transmitted. In a slot of a multi-slot PUSCH, the WTRU may use symbol allocation (e.g., the same symbol allocation). As described herein, using the same symbol allocation in a slot of a multi slot PUSCH may be referred to as multi-slot transmission.

In examples, a TB (e.g., whether on a slot or one or more slots) may be repeated. The number of repetitions may be indicated to the WTRU in the DCI and/or configured.

In examples, one or more REs of one or more PUSCH resources in an OFDM may be reserved. In examples, one or more REs of one or more PUSCH resources in an OFDM may not be used for PUSCH transmission. One or more data symbols, which may be mapped to the reserved REs, may be punctured. In the punctured REs, the WTRU may transmit a signal (e.g., to reduce the PAPR). As described herein, a pattern of the REs reserved may be referred to as a puncturing pattern.

A puncturing pattern may define which RE(s) of a physical uplink shared channel (PUSCH) resource allocation may be punctured. In examples, the same puncturing pattern may be applied to one or more orthogonal frequency-division multiplexing (OFDM) symbols of a slot. In examples, the pattern may differ between slots.

In examples, there may be up to N (e.g., N) puncturing patterns defined. The one or more patterns to apply may be configured and/or indicated to the WTRU. In examples, in a puncturing pattern (e.g., a first puncturing pattern), k^{th} RE in an RB may be reserved. In examples, in a puncturing pattern (e.g., a second puncturing pattern), (k/2)^{th} RE in an RB may be reserved, and/or the like.

The puncturing pattern may be determined by at least one of the following: one of the configured puncturing patterns may be indicated in the DCI; more than one of the configured puncturing patterns may be indicated in the DCI; the puncturing pattern may be determined by a slot index of a multi-slot transmission; the scheduling DCI may indicate a pattern and/or the pattern may be configured; the redundancy version may determine the pattern; the repetition number of a slot may be configured; one or more same patterns may be applied to one or more repetitions; and/or the WTRU may determine which pattern(s) to apply for different slots and/or repetition(s) and/or RV(s).

In examples, one of the configured puncturing patterns may be indicated in the DCI. The same pattern may apply to one or more (e.g., all) slots of a multi slot PUSCH transmission.

In examples, more than one of the configured puncturing patterns may be indicated in the DCI. An indicated pattern may apply to a group of slots of a multi-slot PUSCH transmission.

In examples, the puncturing pattern may be determined by a slot index of a multi slot transmission. In examples, in a slot (e.g., a first slot), a pattern (e.g., a first pattern) may be used and in a slot (e.g., a second slot), a pattern (e.g., a second pattern) may be used, etc. In examples, a pattern (e.g., a first pattern) may be used in a slot (e.g., a first slot), and a pattern (e.g., a second pattern) may be used in one or more remaining slots. The pattern-to-slot mapping may be configured and/or specified.

In examples, the scheduling DCI may indicate a pattern and/or the pattern may be configured. The pattern to apply in the multiple slots may be determined from the indicated pattern. For example, the DCI may indicate a pattern in which the k^{th} RE in an RB may be reserved. From the indication, the WTRU may determine that in a slot (e.g., a first slot), the indicated pattern may be used. The WTRU may determine that in a slot (e.g., a second slot), a pattern (e.g., a new pattern) may be applied. For example, the pattern for the second slot (e.g., the new pattern for the second slot) may indicate to reserve the (2k)^{th} RE and/or the (k/2)^{th} RE.

In examples, the redundancy version may determine the pattern. For example, the WTRU may determine to apply a pattern (e.g., a first pattern) in a slot with RV0 and a pattern (e.g., a second pattern) in a slot with RV1, etc. The RV-to-pattern mapping may be configured and/or specified.

In examples, the repetition number of a slot may be configured. In examples, a TB may be transmitted in a slot, and the TB may be repeated over one or more slots. In examples, a TB may be transmitted over one or more slots (e.g., 4 slots), and a 4-slot transmission may be repeated (e.g., resulting in a 12-slot transmission if the number of repetitions may be 3). For example, the first 4 slots may be said to have repetition number 1, the second 4 slots may be said to have repetition number 2, etc.

In examples, one or more same patterns may be applied to one or more repetitions, where the pattern(s) applicable to a slot (and/or multi-slot) may be determined by at least one of the following: a pattern-to-repetition number may be configured and/or indicated, and/or a pattern for a slot index for multi-slot and/or repetition number pair may be configured and/or indicated.

In examples, a pattern-to-repetition number may be configured and/or indicated in the scheduling DCI. For example, the same pattern may be applied to one or more slots of a repetition.

In examples, a pattern for a slot index for multi-slot and/or repetition number pair may be configured, and/or indicated in the DCI.

In examples, the WTRU may determine which pattern(s) to apply for different slots and/or repetition(s) and/or RV(s). The selected pattern(s) may be selected from a list of configured patterns. The WTRU may report the selected pattern to a base station (e.g., a gNB), for example, in a MAC CE and/or in L1 signaling (e.g., in PUCCH and/or PUSCH).

In an example, in an alternative to and/or in addition to puncturing one or more reserved REs, the WTRU may calculate a TB size and/or rate to match the encoded bits, considering that the reserved REs may be unavailable for PUSCH transmission. For example, the WTRU may determine the reserved pattern using one or more examples described herein.

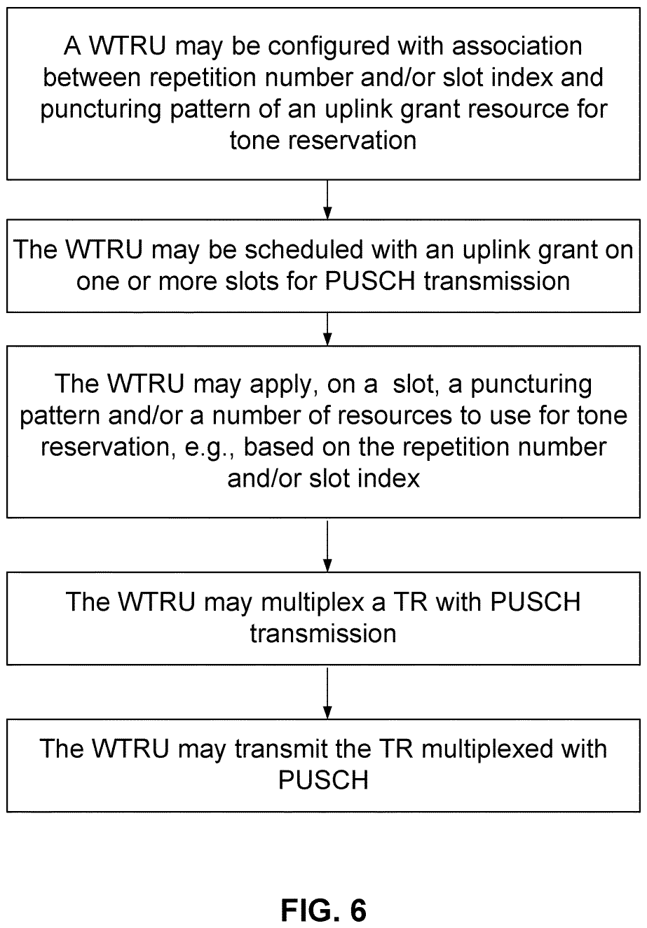

FIG. 6 illustrates an example flow diagram of determining one or more TR resources for one or more slot transmissions. As illustrated in FIG. 6, a WTRU may be configured and/or preconfigured with an association between a repetition number and/or a slot index and a puncturing pattern for an uplink grant and/or an association between a repetition number and/or a slot index and a percentage of one or more uplink grant resources that may be used for tone reservation. As illustrations of described herein, for example, the WTRU may receive a configuration and/or configuration information. In examples, the WTRU may receive the configuration information from a base station, such as a gNB. The configuration information may indicate a puncturing pattern associated with an uplink transmission. In examples, the configuration information may associate at least one of a repetition number and the puncturing pattern or a slot index and the puncturing pattern. In examples, the configuration information may indicate a number of resources to be used for a tone transmission. The tone transmission may be associated with the tone for the uplink transmission. The puncturing pattern may indicate one or more REs to be punctured for the uplink transmission.

As illustrated in FIG. 6, the WTRU may be scheduled with the uplink grant on one or more slots. A base station, such as a gNB, may indicate a number of repetitions, and/or a number of slots for PUSCH transmission. As illustrations of described herein, the WTRU may receive an uplink grant. The uplink grant may be associated with the uplink transmission. In examples, the WTRU may receive an uplink grant on a slot for a transmission. The uplink grant may indicate at least one of a number of repetitions or a number of slots for the transmission. The uplink grant may be, or may include, downlink control information (DCI). Based on the DCI, the WTRU may determine the puncturing pattern. As described herein, the puncturing pattern may be applied to the slot for a multi slot transmission associated with the uplink transmission. In examples, the WTRU may determine the puncturing pattern based on at least one of a slot index associated with a multi-slot transmission for the uplink transmission, a pattern indicated in the DCI, a configured redundancy version, or a repetition number of slots associated with the uplink transmission.

As illustrations of described herein, in examples, based on the DCI, the WTRU may determine the first puncturing pattern and a second puncturing pattern. The first puncturing pattern may apply to the first group of slots for a multi-slot transmission associated with the uplink transmission. The second puncturing pattern may apply to a second group of slots for the multi-slot transmission associated with the uplink transmission.

Based on the configuration information and/or the uplink grant, the WTRU may apply the puncturing pattern to a slot associated with the uplink transmission. For example, as illustrated in FIG. 6, a WTRU may apply, on a slot, a puncturing pattern and/or a number of resources to use for tone reservation. For example, this may be based on the repetition number and/or a slot index. The puncturing pattern may be (e.g., may further be associated) with multiplexing a tone with data for the uplink transmission. In examples, the WTRU may apply the puncturing pattern to the slot for the transmission based on the configuration. For example, the WTRU may multiplex tone reservation with data transmission.

As illustrated in FIG. 6, the WTRU may multiplex tone reservation transmission with data transmission using the selected TR multiplexing scheme. Also, as illustrated in FIG. 6, the WTRU may transmit TR multiplexed with PUSCH transmission. As described herein, the WTRU may send the uplink transmission. For example, the WTRU may multiplex the tone with the data in accordance with the puncturing pattern. In examples, the WTRU may perform the transmission. For example, the WTRU may perform PUSCH transmission. The PUSCH transmission may be, or may include, the data transmission and/or the tone reservation transmission.

Although features and elements described above are described in particular combinations, each feature or element may be used alone, without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-20. (canceled)

21. A wireless transmit/receive unit (WTRU), comprising:
a processor configured to:
receive configuration information from a base station, wherein the configuration information indicates a first transmit power range and a second transmit power range;
determine a transmit power to be used for an uplink transmission;
determine that the transmit power is in a transmit power range, wherein the determined transmit power range is the first transmit power range or the second transmit power range; and
determine to use a multiplexing scheme that corresponds to the determined transmit power range.

22. The WTRU of claim 21, wherein the first transmit power range is associated with a first multiplexing scheme and the second transmit power range is associated with a second multiplexing scheme, and the determined multiplexing scheme is the first multiplexing scheme or the second multiplexing scheme.

23. The WTRU of claim 21, wherein the processor is further configured to:
based on the determination to use the multiplexing scheme, send the uplink transmission, wherein being configured to send the uplink transmission comprises the processor being configured to send a tone with data in accordance with the determined multiplexing scheme.

24. The WTRU of claim 23, wherein the first transmit power range is associated with a first multiplexing scheme, wherein the determined transmit power range is the first transmit power range and the determined multiplexing scheme is the first multiplexing scheme, and wherein being configured to send the tone with the data in accordance with the determined multiplexing scheme comprises the processor being configured to multiplex the tone with the data in accordance with the first multiplexing scheme.

25. The WTRU of claim 23, wherein the second transmit power range is associated with a second multiplexing scheme, wherein the determined transmit power range is the second transmit power range and the determined multiplexing scheme is the second multiplexing scheme, and wherein being configured to send the tone with the data in accordance with the determined multiplexing scheme comprises the processor being configured to send the tone with the data in accordance with the second multiplexing scheme.

26. The WTRU of claim 23, wherein the tone that is being multiplexed with the data is associated with a tone reservation signal.

27. The WTRU of claim 21, wherein the first transmit power range is associated with at least one of a first puncturing pattern configured to multiplex a tone with data or a first number of resource elements (REs) configured to multiplex a tone with data using a rate matching, wherein the second transmit power range is associated with at least one of a second puncturing pattern configured to multiplex a tone with data or a second number of REs configured to multiplex a tone with data using the rate matching, and wherein the second puncturing pattern differs from the first puncturing pattern and wherein the first number of REs differs from the second number of REs.

28. The WTRU of claim 21, wherein the processor is configured to:
send an indication to the base station, wherein the indication indicates the determined multiplexing scheme being used for the uplink transmission, and wherein the indication is sent using at least one of uplink control information (UCI) or medium access control (MAC) control element (CE).

29. The WTRU of claim 21, wherein the first transmit power range and the second transmit power range are associated with at least one of absolute values associated with powers, offsets associated with a maximum transmission power, or offsets associated with a configured maximum transmission power for the uplink transmission.

30. The WTRU of claim 21, wherein the configuration information is configured for a period of time or a number of uplink grants.

31. A method comprising:
receiving configuration information from a base station, wherein the configuration information indicates a first transmit power range and a second transmit power range;
determining a transmit power to be used for an uplink transmission;
determining that the transmit power is in a transmit power range, wherein the determined transmit power range is the first transmit power range or the second transmit power range; and
determining to use a multiplexing scheme that corresponds to the determined transmit power range.

32. The method of claim 31, wherein the first transmit power range is associated with a first multiplexing scheme and the second transmit power range is associated with a second multiplexing scheme, and the determined multiplexing scheme is the first multiplexing scheme or the second multiplexing scheme.

33. The method of claim 31, wherein the method further comprises:
based on the determination to use the multiplexing scheme, sending the uplink transmission, wherein sending the uplink transmission comprises sending a tone with data in accordance with the determined multiplexing scheme.

34. The method of claim 33, wherein the first transmit power range is associated with a first multiplexing scheme, wherein the determined transmit power range is the first transmit power range and the determined multiplexing scheme is the first multiplexing scheme, and wherein sending the tone with the data in accordance with the determined multiplexing scheme comprises multiplexing the tone with the data in accordance with the first multiplexing scheme.

35. The method of claim 33, wherein the second transmit power range is associated with a second multiplexing scheme, wherein the determined transmit power range is the second transmit power range and the determined multiplexing scheme is the second multiplexing scheme, and wherein sending the tone with the data in accordance with the determined multiplexing scheme comprises sending the tone with the data in accordance with the second multiplexing scheme.

36. The method of claim 33, wherein the tone that is being multiplexed with the data is associated with a tone reservation signal.

37. The method of claim 31, wherein the first transmit power range is associated with at least one of a first puncturing pattern configured to multiplex a tone with data or a first number of resource elements (REs) configured to multiplex a tone with data using a rate matching, wherein the second transmit power range is associated with at least one of a second puncturing pattern configured to multiplex a tone with data or a second number of REs configured to multiplex a tone with data using the rate matching, and wherein the second puncturing pattern differs from the first puncturing pattern and wherein the first number of REs differs from the second number of REs.

38. The method of claim 31, wherein the method comprises:
sending an indication to the base station, wherein the indication indicates the determined multiplexing scheme being used for the uplink transmission, wherein the indication is sent using at least one of uplink control information (UCI) or medium access control (MAC) control element (CE).

39. The method of claim 31, wherein the first transmit power range and the second transmit power range are associated with at least one of absolute values associated with powers, offsets associated with a maximum transmission power, or offsets associated with a configured maximum transmission power for the uplink transmission.

40. The method of claim 31, wherein the configuration information is configured for a period of time or a number of uplink grants.
